(19) United States
(12) Patent Application Publication
(10) Pub. No.: US 2016/0039206 A1
(43) Pub. Date: Feb. 11, 2016

(54) ETCHING METHOD AND METHOD OF MANUFACTURING LIQUID DISCHARGE HEAD SUBSTRATE

(71) Applicant: CANON KABUSHIKI KAISHA, Tokyo (JP)

(72) Inventors: Takashi Usui, Ashigarakami-gun (JP); Toshiyasu Sakai, Kawasaki-shi (JP); Yuzuru Ishida, Yokohama-shi (JP); Hisanori Hosaka, Oita-shi (JP)

(21) Appl. No.: 14/794,947

(22) Filed: Jul. 9, 2015

(30) Foreign Application Priority Data
Aug. 6, 2014 (JP) 2014-160797

(51) Int. Cl. B41J 2/16

(52) U.S. Cl. CPC B41J 2/1628; B41J 2/162; B41J 2/1642

(57) ABSTRACT

An etching method of etching a first member containing iridium is provided. The method includes forming a second member above the first member, forming a first mask pattern on the second member, forming a second mask pattern by etching the second member using the first mask pattern and etching the first member using the first mask pattern and the second mask pattern. In etching the first member, the first member is etched on a condition that the first mask pattern shrinks and an upper surface of the second mask pattern is partially exposed.

### BACKGROUND OF THE INVENTION

1. Field of the Invention

The present invention relates to an etching method and a method of manufacturing a liquid discharge head substrate.

2. Description of the Related Art

A liquid discharge head substrate includes a portion which applies energy to a liquid to discharge the liquid and a protection layer for protecting the portion from the shock of cavitation caused when the liquid generates bubbles. Japanese Patent Laid-Open No. 2012-183681 describes that a stacked structure containing iridium is used as the protection layer. As a result, the anti-cavitation capability of the protection layer improves. Furthermore, Japanese Patent Laid-Open No. 2000-133783 describes a method of retreating the side wall of a resist mask by using a processing gas obtained by adding oxygen to chlorine gas when patterning an iridium layer by dry etching using the resist mask. As a result, a reaction product which adheres to the side wall of a pattern is removed, and a highly accurate and fine pattern of the iridium layer can be formed.

### SUMMARY OF THE INVENTION

When etching the iridium layer by a method described in Japanese Patent Laid-Open No. 2000-133783, the side surface of a resist mask on the iridium layer retreats, and thus the end portion of the upper surface of the iridium layer may be exposed. The present inventors have found that this exposed portion may be roughened greatly if it is exposed to a plasma used in the etching process. In this case, the upper surface of the iridium layer locally includes a greatly roughened portion after removing the resist mask. If the method described in Japanese Patent Laid-Open No. 2000-133783 is used to form a structure described in Japanese Patent Laid-Open No. 2012-183681, another film is deposited on the iridium layer having such an upper surface. As a result, for example, the adhesion between this film and the iridium layer may degrade, resulting in peeling off the film. Some embodiments of the present invention provide a technique of reducing the roughness of a member containing iridium caused when etching the member.

According to some embodiments, an etching method of etching a first member containing iridium, the method comprising: forming a second member above the first member; forming a first mask pattern on the second member; forming a second mask pattern by etching the second member using the first mask pattern; and etching the first member using the first mask pattern and the second mask pattern, wherein in etching the first member, the first member is etched on a condition that the first mask pattern shrinks and an upper surface of the second mask pattern is partially exposed, is provided.

According to some other embodiments, a method of manufacturing a liquid discharge head substrate, the method comprising: forming, above a substrate where a semiconductor element is arranged, an element configured to generate energy to be used in discharging a liquid; forming, above the element, a first member containing iridium; forming a second member above the first member; forming a first mask pattern on the second member; forming a second mask pattern by etching the second member using the first mask pattern; and etching the first member using the first mask pattern and the second mask pattern, wherein in etching the first member, the first member is etched on a condition that the first mask pattern shrinks and an upper surface of the second mask pattern is partially exposed, is provide.

Further features of the present invention will become apparent from the following description of exemplary embodiments (with reference to the attached drawings).

### BRIEF DESCRIPTION OF THE DRAWINGS

FIG. 1 is a partially cutaway perspective view showing a liquid discharge head substrate according to an embodiment of the present invention;

FIG. 2 is a sectional view showing the liquid discharge head substrate in FIG. 1;

FIGS. 3A to 3E are sectional views showing the steps in a method of manufacturing the liquid discharge head substrate in FIG. 1;

FIG. 4 is a sectional view showing a liquid discharge head substrate according to an embodiment of the present invention; and

FIG. 5 is a sectional view showing a liquid discharge head substrate according to an embodiment of the present invention.

### DESCRIPTION OF THE EMBODIMENTS

Practical embodiments of an etching method and a method of manufacturing a semiconductor device according to the present invention will be described below. In the following embodiments, a liquid discharge head substrate is used as an example of the semiconductor device. However, the present invention is not limited to this.

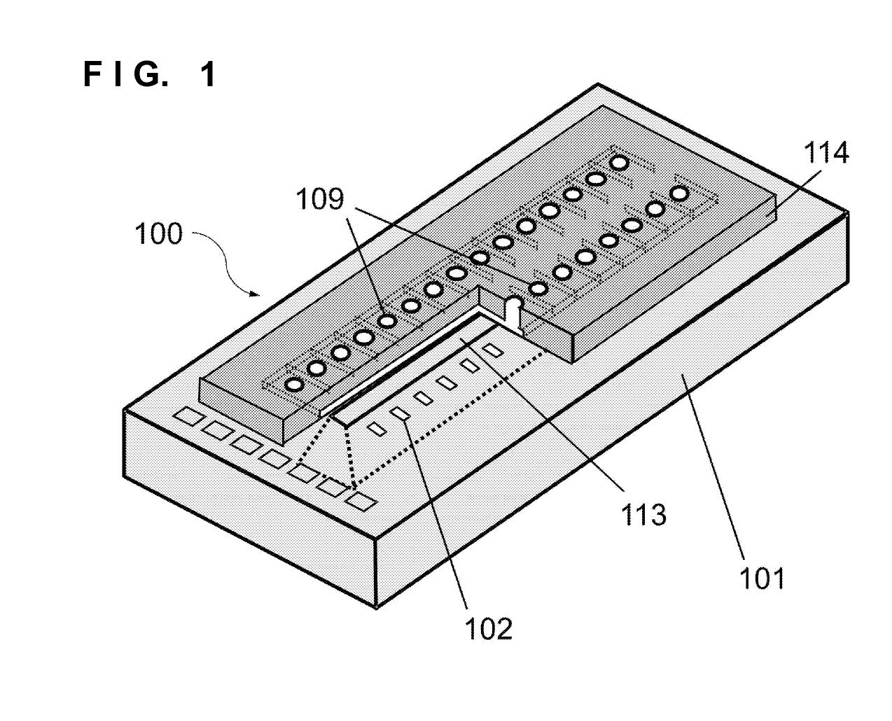

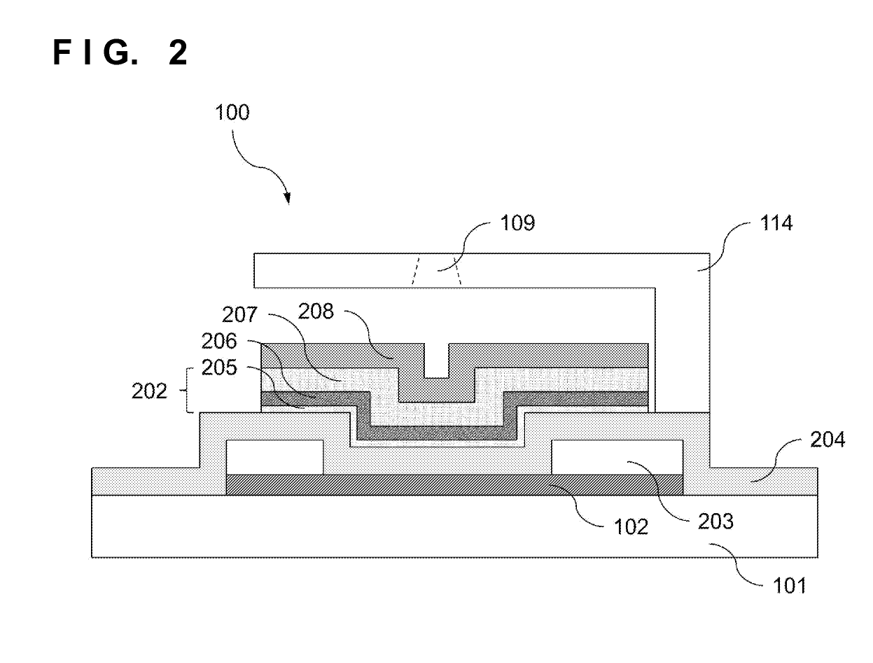

The structure of the liquid discharge head substrate according to some embodiments of the present invention will be described with reference to FIGS. 1 and 2. FIG. 1 is a partially cutaway perspective view schematically showing an example of the arrangement of a liquid discharge head substrate 100 according to a first embodiment of the present invention. The liquid discharge head substrate 100 according to this embodiment includes a plurality of heaters 102 on a substrate 101 where a liquid supply port 113 having a long groove-shaped through-hole to supply a liquid such as ink is open. A channel member which forms a channel (not shown) through which the liquid flows and a plate 114 where an orifice 109 corresponding to each heater 102 is provided are formed on the substrate 101, thereby forming the liquid discharge head substrate 100. If the liquid is supplied from the liquid supply port 113 to the channel, each heater 102 provided in the channel applies thermal energy to the liquid and the liquid is discharged from the corresponding orifice 109 by a bubble generated in the liquid.

FIG. 2 is a sectional view schematically showing an example of the arrangement of the periphery of one heater of the liquid discharge head substrate 100 according to this embodiment. The heater 102 which generates heat by being energized is provided on the substrate 101. A wiring layer 203 for supplying power to the heater 102 is provided on this heater 102. Furthermore, an insulating layer 204 is provided on the substrate 101 so as to cover the heater 102 and the wiring layer 203. A protection layer 202 for protecting the heater 102 from the shock of cavitation caused when generating the bubble is provided in a region facing the heater 102 on the insulating layer 204. The protection layer 202 may also be called an anti-cavitation layer. In this embodiment, the protection layer 202 is formed by three layers of a lower protection layer 205 serving as the first protection layer, an iridium layer 206 formed from iridium serving as the first member, and an upper protection layer 207 serving as the second protection layer. A hard mask layer 208 serving as the second member is provided on the protection layer 202. The plate 114 including the orifice 109 is provided spaced above these structures.

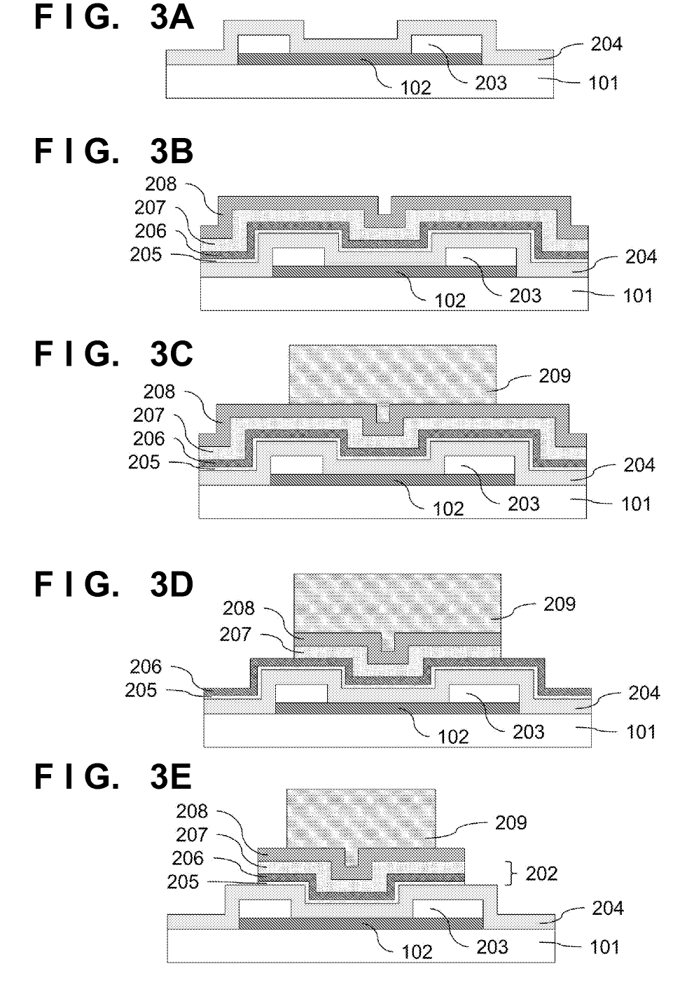

A method of manufacturing the above-described liquid discharge head substrate 100 according to this embodiment will now be described with reference to FIGS. 3A to 3E. A material such as TaSiN is deposited, by using a sputtering method or the like, with the thickness of, for example, 20 nm on the substrate 101 where a driving circuit (not shown) including a semiconductor element such as a switching transistor configured to drive the heater 102 selectively is formed. Next, a material such as an Al—Cu based alloy is deposited, by using the sputtering method or the like, with the thickness of, for example, 600 nm. Then, the film of the Al—Cu based alloy is etched by performing a photolithography process and dry etching using a processing gas such as Cl₂ gas, thereby forming the wiring layer 203. After that, the film of TaSiN is etched by performing the photolithography process and wet etching using a mixed acid, thereby forming the heater 102.

Then, the insulating layer 204 is formed, by using CVD method or the like, on the substrate 101 so as to cover the heater 102 and the wiring layer 203. In this embodiment, the insulating layer 204 is formed from SiN and has the thickness of, for example, 300 nm. Note that the insulating layer 204 suffices to be able to insulate the heater 102 and the wiring layer 203 from the liquid, and may use an insulating material such as SiO, SiC, or SiCN. FIG. 3A shows a section after the end of this step.

Next, the protection layer 202 for protecting the heater 102 from cavitation caused when a bubble generated at the time of liquid discharge disappears is formed on the insulating layer 204. In this embodiment, the protection layer 202 is formed by the three layers, and forms, by using the sputtering method or the like, 20-nm tantalum as the lower protection layer 205, the 40-nm iridium layer 206, and 100-nm tantalum as the upper protection layer 207, respectively. In this embodiment, the sum of film thicknesses of the lower protection layer 205 and the iridium layer 206 is smaller than the film thickness of the upper protection layer 207. Note that the lower protection layer 205 suffices to have a film thickness capable of ensuring the adhesion between the insulating layer 204 and the iridium layer 206. The lower protection layer 205 is formed to have the thickness of, for example, 5 nm to 100 nm. The iridium layer 206 is formed to have a thickness that can endure the shock of cavitation to be generated of the number of discharge operations required for the liquid discharge head. The iridium layer 206 is formed to have the thickness of, for example, 10 nm to 100 nm. The upper protection layer 207 has a thickness that can sufficiently cover the iridium layer 206. The upper protection layer 207 is formed to have a thickness of, for example, 30 nm to 200 nm. Note that the upper protection layer 207 has a function of preventing a burn from physically adsorbing to the surface of the iridium layer 206. The burn refers to a hardly soluble substance obtained by decomposing, at the molecular level, a color material and an additive contained in ink in high-temperature heating. Droplet discharge may become unstable if the burn adheres to a film surface.

Further, as shown in FIG. 3B, the hard mask layer 208 serving as the second member is formed, by using CVD method, on the upper protection layer 207. For example, an inorganic material other than a metal is used for the hard mask layer 208. In this embodiment, SiO₂ is used to form the hard mask layer 208 with the thickness of 100 nm. If the film thickness of the hard mask layer 208 is large, pattern formation becomes difficult when etching is performed in the next step to form the second mask pattern. The hard mask layer 208 does not function as a hard mask if its film thickness is small.

Then, as shown in FIG. 3C, a first mask pattern 209 is formed on the hard mask layer 208. The first mask pattern 209 covers at least a portion of the heater 102 that should be protected from cavitation and has openings in other portions. In this embodiment, a photoresist made of an organic material is used as a material for the first mask pattern. The photoresist is coated onto the substrate 101 covered with the hard mask layer 208, and desired patterning is performed by an exposure device, thereby forming the first mask pattern 209. In this case, the thickness of a photoresist film is about, for example, 2.5 μm. The film thickness of this photoresist suffices to have an adequate resistance as a mask when etching the hard mask layer 208.

Subsequently, the hard mask layer 208 is etched to form the second mask pattern, and the protection layer 202 formed by the three layers is also etched. More specifically, first, by a dry etching method or the like using the first mask pattern 209, the portion of the hard mask layer 208 and the upper protection layer 207 lying under the opening portion of the first mask pattern 209 is etched. In this embodiment, processing gases such as Cl₂ gas and BCl₃ gas are introduced into a reaction chamber where etching is performed, and a pressure in the reaction chamber is controlled to be 1.33 Pa (10 mTorr) to 2.67 Pa (20 mTorr). After the reaction chamber is stabilized, a high-frequency power of 13.56 MHz is applied to the upper part and the lower part of the electrode of the reaction chamber, thereby generating a plasma and performing etching. In this case, while the first mask pattern 209 is etched slightly, the hard mask layer 208 and the upper protection layer 207 are etched faster than the first mask pattern 209. Therefore, no step is formed in each side wall between the first mask pattern 209, and the hard mask layer 208 and the upper protection layer 207. FIG. 3D shows a section after the end of this step.

Next, the iridium layer 206 is etched, by using the dry etching method or the like, through the opening portion of the first mask pattern 209 and the hard mask layer 208 where the second mask pattern are formed. Processing gases such as Cl₂ gas, O₂ gas, and Ar are introduced into the reaction chamber where etching is performed, and the pressure in the reaction chamber is controlled to be 0.667 Pa (5 mTorr) to 1.33 Pa (10 mTorr). After the reaction chamber is stabilized, the high-frequency power of 13.56 MHz is applied to the upper electrode and the lower electrode of the reaction chamber, thereby generating a plasma and performing etching.

Since O₂ gas is added to, or contained in, the processing gases, an etching reaction proceeds faster in the first mask pattern 209 formed by the organic material than in the hard mask layer 208. Therefore, the area of the first mask pattern 209 covering the hard mask layer 208 is reduced, or shrinks. More specifically, each side surface of the first mask pattern 209 retreats by about 1 to 2 μm with respect to the corresponding side surface of the hard mask layer 208, partially exposing the upper surface of the hard mask layer 208. Furthermore, since etching proceeds while cutting each side surface of the first mask pattern 209, iridium deposits adhering to the side surface of the first mask pattern 209 can be reduced. This makes it possible to suppress a separation failure caused in a separation processing step of separating these deposits and increase a manufacturing yield. Furthermore, since O₂ gas is added to the processing gases, tantalum oxide is generated on the surface of the lower protection layer 205 lying under the iridium layer 206. As a result, etching is less likely to proceed on the surface of the lower protection layer 205, and an effect of increasing selectivity between the lower protection layer 205 and the iridium layer 206 is also obtained.

Next, the lower protection layer 205 is etched by using the second mask pattern formed by the hard mask layer 208. An etching condition in this case can be the same as a condition when etching the upper protection layer 207. Further, for example, the pressure in the reaction chamber may be controlled to be high so as not to etch the insulating layer 204 under the lower protection layer 205. Furthermore, the processing gases may be changed. FIG. 3E shows a section after the end of this step. A nozzle material film (not shown) is formed after forming this protection layer.

The effect of this embodiment will now be described. If the manufacturing method described in Japanese Patent Laid-Open No. 2000-133783 is applied to etch the iridium layer, etching of the photoresist made of the organic material proceeds and the photoresist is retreated further than the formed mask pattern because O₂ gas is added to the processing gases for etching. If this is applied to the arrangement of the liquid discharge head substrate described in Japanese Patent Laid-Open No. 2012-183681, the end portion of the iridium layer exposed when being etched is exposed to a plasma in an etching process. The upper surface of the iridium layer exposed to a plasma in this etching process may be roughened locally and greatly. If a film is deposited on such a locally roughened iridium layer in the succeeding steps, the adhesion of the film may degrade, resulting in peeling of the film.

In this embodiment, the hard mask layer 208 is difficult to etch in the etching process of the iridium layer 206. Therefore, roughness that may cause trouble in steps after the formation of the protection layer does not occur on the upper surface of the hard mask layer 208. Since the hard mask layer 208 exists, at the end of etching, on the entire upper surfaces of the upper protection layer 207 and the iridium layer 206 under the hard mask layer 208, it is not exposed to a plasma in the etching process. This suppresses the problem of film peeling caused by degradation in the adhesion of the film deposited on the hard mask layer 208 in the steps after the formation of the protection layer. As a result, the manufacturing yield is increased.

After that, the plate 114 including the orifices 109 is formed. These arrangements can be formed by using an existing method, and thus a detailed description thereof will be omitted. The liquid discharge head substrate 100 shown in FIGS. 1 and 2 is formed by the above-described process.

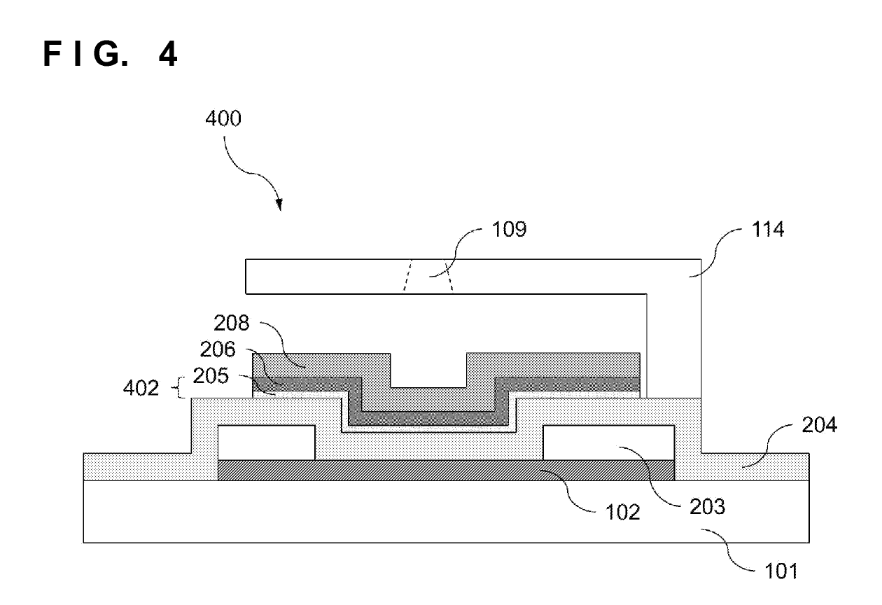

The structure of a liquid discharge head substrate 400 according to a second embodiment of the present invention will be described with reference to FIG. 4. FIG. 4 is a sectional view schematically showing an example of the arrangement of the periphery of one heater of the liquid discharge head substrate 400 according to the second embodiment of the present invention. The liquid discharge head substrate 400 according to this embodiment in FIG. 4 can be the same as the liquid discharge head substrate 100 according to the first embodiment except that it does not include an upper protection layer 207 in a protection layer 402. Therefore, a repetitive description on the same components as those of the liquid discharge head substrate 100 will be omitted.

A method of manufacturing the liquid discharge head substrate 400 will now be described. The method according to this embodiment is the same as the method of manufacturing the liquid discharge head substrate 100 up to a step of forming an iridium layer 206. After forming the iridium layer 206, a hard mask layer 208 is formed by using CVD method or the like. Then, a first mask pattern 209 is formed on the hard mask layer 208. Next, the portion of the hard mask layer 208 lying under the opening portion of the first mask pattern 209 is etched by using a dry etching method or the like, thereby forming the second mask pattern. In this case, while the first mask pattern 209 is etched slightly, the hard mask layer 208 is etched faster than the first mask pattern 209. Therefore, no step is formed in each side wall between the hard mask layer 208 and the first mask pattern 209.

Next, the portion of the iridium layer 206 lying under the opening portion of the first mask pattern 209 and the hard mask layer 208 where the second mask pattern are formed is etched by using the dry etching method or the like. Next, a lower protection layer 205 is etched by using the second mask pattern formed by the hard mask layer 208, thereby forming the protection layer 402. After forming this protection layer 402, the liquid discharge head substrate 400 is formed by the same process as in the method of manufacturing the liquid discharge head substrate 100.

Also in this embodiment, no roughness occurs on the upper surface of the hard mask layer 208 in a step of etching the iridium layer 206 and the lower protection layer 205. Since the hard mask layer 208 exists on the iridium layer 206 at the end of etching, the upper surface of the iridium layer 206 is not exposed to a plasma in an etching process. Therefore, the same effect as in the method of manufacturing the liquid discharge head substrate 100 described in the first embodiment can also be obtained in the method of manufacturing the liquid discharge head substrate 400 according to this embodiment.

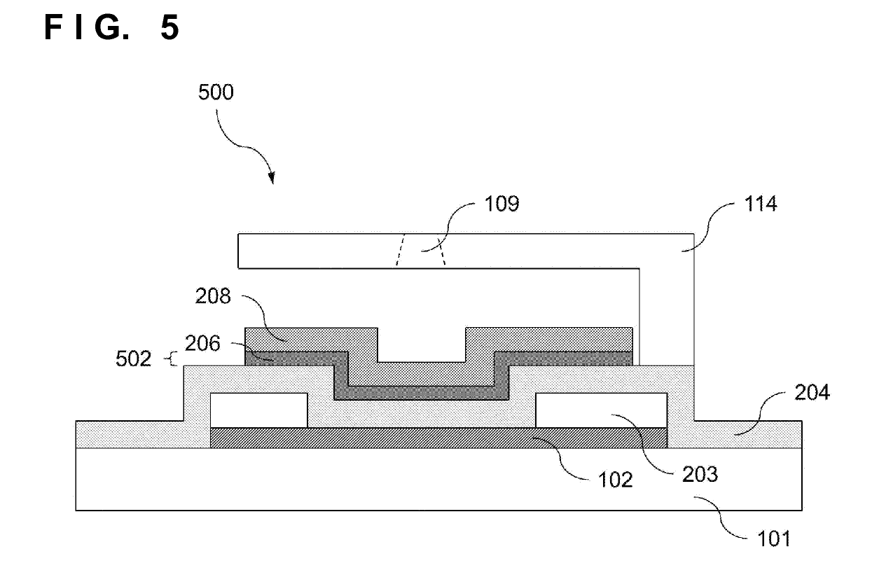

The structure of a liquid discharge head substrate 500 according to a third embodiment of the present invention will be described with reference to FIG. 5. FIG. 5 is a sectional view schematically showing an example of the arrangement of the periphery of one heater of the liquid discharge head substrate 500 according to the third embodiment of the present invention. The liquid discharge head substrate 500 according to this embodiment in FIG. 5 can be the same as the liquid discharge head substrates 100 and 400 according to the first and second embodiments except that it includes only an iridium layer 206 in a protection layer 502. Therefore, a repetitive description on the same components as those of the liquid discharge head substrate 400 will be omitted.

A method of manufacturing the liquid discharge head substrate 500 will now be described. The method according to this embodiment is the same as the method of manufacturing each of the liquid discharge head substrates 100 and 400 up to a step of forming an insulating layer 204. After forming the insulating layer 204, the iridium layer 206 is formed by using a sputtering method or the like, and a hard mask layer 208 is further formed on the iridium layer 206 by using CVD method or the like. Then, a first mask pattern 209 is formed on the hard mask layer 208. Next, the portion of the hard mask layer 208 lying under the opening portion of the first mask pattern 209 is etched by using a dry etching method or the like, thereby forming the second mask pattern. In this case, while the first mask pattern 209 is etched slightly, the hard mask layer 208 is etched faster than the first mask pattern 209. Therefore, no step is formed in each side wall between the hard mask layer 208 and the first mask pattern 209.

Next, the portion of the iridium layer 206 lying under the opening portion of the first mask pattern 209 and the hard mask layer 208 where the second mask pattern are formed is etched by using the dry etching method or the like, thereby forming the protection layer. After forming this protection layer, the liquid discharge head substrate 500 is formed by the same process as in the method of manufacturing each of the liquid discharge head substrates 100 and 400.

Also in this embodiment, no roughness occurs on the upper surface of the hard mask layer 208 in this etching step. Since the hard mask layer 208 exists on the iridium layer 206 at the end of etching, the upper surface of the iridium layer 206 is not exposed to a plasma in an etching process. Therefore, the same effect as in the method of manufacturing each of the liquid discharge head substrates 100 and 400 described in the first and second embodiments can also be obtained in the method of manufacturing the liquid discharge head substrate 500.

The three embodiments according to the present invention have been described above. However, the present invention is not limited to these embodiments. The present invention may be applied to, for example, a liquid discharge head substrate which discharges a liquid by applying, using a piezoelectric element or the like, a mechanical force to the liquid. Further, an etching method of the present invention can also be applied to a method of manufacturing another semiconductor device, such as a storage device or an arithmetic processing device.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-160797, filed Aug. 6, 2014, which is hereby incorporated by reference wherein in its entirety.

What is claimed is:

1. An etching method of etching a first member containing iridium, the method comprising:
forming a second member above the first member;
forming a first mask pattern on the second member;
forming a second mask pattern by etching the second member using the first mask pattern; and
etching the first member using the first mask pattern and the second mask pattern,
wherein in etching the first member, the first member is etched on a condition that the first mask pattern shrinks and an upper surface of the second mask pattern is partially exposed.

2. The method according to claim 1, wherein at an end of etching the first member, an entire upper surface of a pattern of the first member is covered with the second mask pattern.

3. The method according to claim 1, wherein O₂ gas is contained in a processing gas used in etching the first member.

4. The method according to claim 1, wherein a material of the second member includes an inorganic material.

5. The method according to claim 4, wherein the material of the second member includes an inorganic material other than a metal.

6. The method according to claim 4, wherein the material of the second member is SiO₂.

7. The method according to claim 1, wherein a material of the first mask pattern includes an organic material.

8. A method of manufacturing a liquid discharge head substrate, the method comprising:
forming, above a substrate where a semiconductor element is arranged, an element configured to generate energy to be used in discharging a liquid;
forming, above the element, a first member containing iridium;
forming a second member above the first member;
forming a first mask pattern on the second member;
forming a second mask pattern by etching the second member using the first mask pattern; and
etching the first member using the first mask pattern and the second mask pattern,
wherein in etching the first member, the first member is etched on a condition that the first mask pattern shrinks and an upper surface of the second mask pattern is partially exposed.

9. The method according to claim 8, further comprising forming a first protection layer above the element before forming the first member,
wherein the method includes etching the first protection layer by using the first mask pattern and the second mask pattern.

10. The method according to claim 8, further comprising forming a second protection layer on the first member before forming the second member,
wherein the method includes etching the second protection layer by using the first mask pattern.

11. The method according to claim 9, wherein the first protection layer is formed from tantalum.

12. The method according to claim 10, wherein the second protection layer is formed from tantalum.

13. The method according to claim 9, further comprising forming a second protection layer on the first member before forming the second member,
wherein the method includes etching the second protection layer by using the first mask pattern, and
a sum of a thickness of the first protection layer and a thickness of the first member is smaller than a thickness of the second protection layer.
